(19) United States
(12) Patent Application Publication
(10) Pub. No.: US 2021/0316729 A1
(43) Pub. Date: Oct. 14, 2021

(54) Vehicle Control Apparatus, Vehicle Control Method, and Vehicle Following Running System

(71) Applicant: Hitachi Astemo, Ltd., Hitachinaka-shi, Ibaraki (JP)

(72) Inventors: Hiroki SUGAWARA, Sagamihara-shi, Kanagawa (JP); Kentaro UENO, Atsugi-shi, Kanagawa (JP)

(21) Appl. No.: 17/272,103

(22) PCT Filed: Jul. 22, 2019
(86) PCT No.: PCT/JP2019/028613

§ 371 Date: Feb. 26, 2021

(30) Foreign Application Priority Data
Aug. 31, 2018 (JP) 2018-163127

(51) Int. Cl. B60W 30/17

(52) U.S. Cl. CPC B60W 30/17; B60W 2720/106; B60W 2554/802; B60W 2556/65

(57) ABSTRACT

A vehicle control apparatus is configured to be mounted on a following vehicle in a vehicle following running system that achieves following running by non-mechanically towing a preceding vehicle and the following vehicle. The vehicle control apparatus is configured to acquire a first physical amount regarding a motion amount of the preceding vehicle generated when the preceding vehicle starts running that is transmitted from the preceding vehicle, determine a second physical amount regarding a motion amount of the following vehicle required when the following vehicle starts running based on the acquired first physical amount, and output an instruction for achieving the determined second physical amount to an actuator regarding driving of the following vehicle.

### TECHNICAL FIELD

The present invention relates to a vehicle following running system that allows a following vehicle to run while following behind a preceding vehicle.

### BACKGROUND ART

For example, there is PTL 1 as the background art in the technical field relating to autonomous running control of a following vehicle that runs while following behind a preceding vehicle by being electronically towed to the preceding vehicle. PTL 1 discloses that the following vehicle receives information indicating a running state such as the vehicle speed and the acceleration, information indicating an operation amount such as the throttle position, the steering angle, and the brake operation amount, and information indicating vehicle specifications such as the vehicle weight and the engine output characteristic with respect to the preceding vehicle, thereby allowing following running control to be performed with a similar operation to an operation provided to the preceding vehicle.

### CITATION LIST

### Patent Literature

PTL 1: Japanese Patent Application Public Disclosure No. H05-170008

### SUMMARY OF INVENTION

### Technical Problem

PTL 1 fails to take into consideration the control when the vehicles start running after being stopped although the following running should be controlled so as to keep the inter-vehicle distance constant regardless of the vehicle speed with the aid of inter-vehicle communication while the vehicles are running. More specifically, an inter-vehicle distance maintained when the vehicles are stopped may have to be shorter than a target inter-vehicle distance sought when the vehicles are running due to a constraint on the parking space or the like, or may even be longer than the target inter-vehicle distance in some cases, and therefore may not necessarily be equal to the target inter-vehicle distance sought when the vehicles are running. The following running control requires a technique for quickly satisfying the target inter-vehicle distance sought when the vehicles are running, after the vehicles start running after being stopped, even in this case.

An object of the present invention is to provide a vehicle control apparatus, a vehicle control method, and a vehicle following running system capable of quickly controlling an inter-vehicle distance to a target inter-vehicle distance sought when vehicles are running, after the vehicles start running after being stopped.

### Solution to Problem

According to one aspect of the present invention, a vehicle control apparatus is configured to be mounted on a following vehicle in a vehicle following running system that achieves following running by non-mechanically towing a preceding vehicle and the following vehicle. The vehicle control apparatus is configured to acquire a first physical amount regarding a motion amount of the preceding vehicle generated when the preceding vehicle starts running that is transmitted from the preceding vehicle, determine a second physical amount regarding a motion amount of the following vehicle required when the following vehicle starts running based on the acquired first physical amount, and output an instruction for achieving the determined second physical amount to an actuator regarding driving of the following vehicle.

### Advantageous Effects of Invention

According to the one aspect of the present invention, it is possible to provide a vehicle control apparatus, a vehicle control method, and a vehicle following running system capable of preventing a delay in the following running when the vehicles start running.

### BRIEF DESCRIPTION OF DRAWINGS

FIG. 1 illustrates a configuration indicating the concept of a vehicle following running system according to a first embodiment.

FIG. 2 are timing charts indicating the vehicle speeds, the accelerations, and the inter-vehicle distance of a preceding vehicle and a following vehicle in a case where the following vehicle starts running with some delay from the preceding vehicle according to a conventional vehicle following running system.

FIG. 3 are timing charts indicating the positions, the inter-vehicle distance, and the vehicle speeds of the preceding vehicle and the following vehicle in a case where the following vehicle sharply speeds up when the vehicles start running according to the conventional vehicle following running system.

FIG. 4 are timing charts indicating the positions, the inter-vehicle distance, and the vehicle speeds of the preceding vehicle and the following vehicle in a case where the following vehicle does not sharply speed up when the vehicles start running according to the conventional vehicle following running system.

FIG. 5 is a block diagram illustrating the configuration of the vehicle following running system according to the first embodiment.

FIG. 6 are timing charts indicating the positions, the inter-vehicle distance, and the vehicle speeds of the preceding vehicle and the following vehicle in a case where an inter-vehicle distance maintained when the vehicles are stopped is shorter than a target inter-vehicle distance sought when the vehicles are running in the vehicle following running system according to the first embodiment.

FIG. 7 are timing charts indicating the positions, the inter-vehicle distance, and the vehicle speeds of the preceding vehicle and the following vehicle in the case where the inter-vehicle distance maintained when the vehicles are stopped is shorter than the target inter-vehicle distance sought when the vehicles are running in a vehicle following running system according to a second embodiment.

FIG. 8 are timing charts indicating the positions, the inter-vehicle distance, and the vehicle speeds of the preceding vehicle and the following vehicle in the case where the inter-vehicle distance maintained when the vehicles are stopped is shorter than the target inter-vehicle distance sought when the vehicles are running in a vehicle following running system according to a third embodiment.

FIG. 9 are timing charts indicating the positions, the inter-vehicle distance, and the vehicle speeds of the preceding vehicle and the following vehicle in a case where the inter-vehicle distance maintained when the vehicles are stopped is longer than the target inter-vehicle distance sought when the vehicles are running in a vehicle following running system according to a fourth embodiment.

### DESCRIPTION OF EMBODIMENTS

In the following description, embodiments of the present invention will be described in detail with reference to the drawings.

### First Embodiment

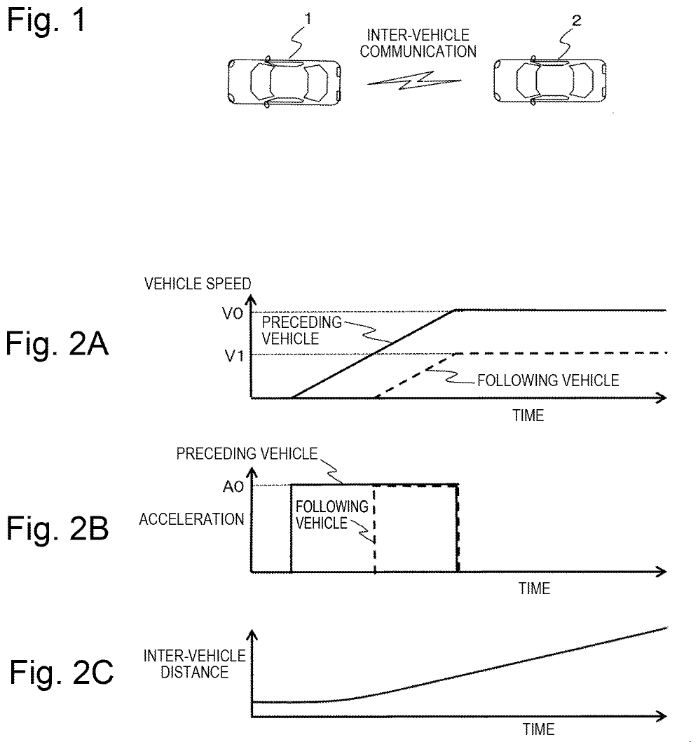

FIG. 1 illustrates a configuration indicating the concept of a vehicle following running system according to the present embodiment. In FIG. 1, 1 and 2 denote a preceding vehicle and a following vehicle running while following behind the preceding vehicle 1, respectively. The preceding vehicle 1 and the following vehicle 2 are equipped with an inter-vehicle communication apparatus, and the following vehicle 2 runs while following behind the preceding vehicle by being electrically and non-mechanically towed to the preceding vehicle 1. The following vehicle autonomously follows behind the preceding vehicle according to an invariably constant target inter-vehicle distance to the preceding vehicle along the same trajectory as the preceding vehicle.

Now, in such a vehicle following running system, when the vehicles are stopped, the inter-vehicle distance maintained at the time of this stop may have to be shorter than the target inter-vehicle distance sought when the vehicles are running due to a reason such as a constraint on the parking space and a purpose of preventing anyone from cutting in between them when the vehicles are stopped, or may even be longer than the target inter-vehicle distance in some cases, and therefore may not necessarily be equal to the target inter-vehicle distance sought when the vehicles are running.

In the following description, a conventional problem will be described. FIG. 2 are timing charts indicating the vehicle speeds, the accelerations, and the inter-vehicle distance of the preceding vehicle and the following vehicle in a case where the vehicles start running from a state that the vehicles are stopped according to the conventional vehicle following running system. FIG. 2 illustrate an example in a case where the following vehicle starts running with some delay from the preceding vehicle and then follows behind the preceding vehicle. In FIG. 2(b), the preceding vehicle increases the acceleration to a predetermined value A0 when starting running, and then sets the acceleration to zero to keep the driving at a constant speed in a state that the speed increases and reaches a predetermined speed V0 as illustrated in FIG. 2(a). On the other hand, the following vehicle runs while following behind the preceding vehicle based on information about the acceleration and the vehicle speed of the preceding vehicle. Then, because the acceleration of the preceding vehicle is zero since when the preceding vehicle reaches the predetermined speed V0 and sets the acceleration to zero, the following vehicle also follows it and sets the acceleration to zero, which means that the following vehicle keeps the constant-speed driving at a speed V1 that is a speed before the following vehicle reaches the predetermined vehicle V0, thereby ending up maintaining a speed difference of V0−V1. Therefore, the inter-vehicle distance between the preceding vehicle and the following vehicle unintentionally increases as illustrated in FIG. 2(c). For example, in vehicle platooning, the increase in the inter-vehicle distance means that the following vehicle collides with another vehicle running behind it, thereby raising a problem. To solve this problem, for example, the following vehicle should start running at the same time as the preceding vehicle.

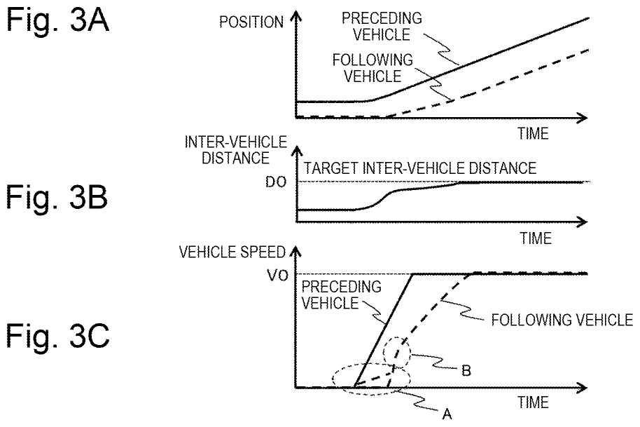

Further, FIG. 3 are timing charts indicating the positions, the inter-vehicle distance, and the vehicle speeds of the preceding vehicle and the following vehicle in the case where the vehicles start running from the state that the vehicles are stopped according to the conventional vehicle following running system. FIG. 3 illustrate an example in a case where the inter-vehicle distance maintained when the vehicles are stopped is shorter than the target inter-vehicle distance sought when the vehicles are running. In FIG. 3(c), the preceding vehicle increases the speed when starting running, and then keeps the driving at a constant speed with the speed thereof reaching the predetermined speed V0. On the other hand, because the inter-vehicle distance maintained when the vehicles are stopped is shorter than the target inter-vehicle distance D0 as illustrated in FIG. 3(b), the following vehicle is kept stopped or starts running at a low speed (a circle A drawn with a broken line) until the inter-vehicle distance increases to a certain degree as illustrated in FIG. 3(c). After that, the following vehicle sharply speeds up to reach the vehicle speed of the preceding vehicle. This case raises a problem such as a reduction in the ride comfort due to the sharp speed-up.

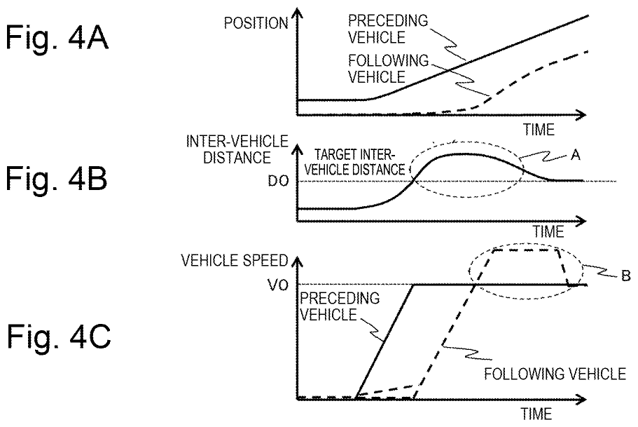

Further, FIG. 4 illustrate an example in a case where the following vehicle does not sharply speed up to solve the above-described problem illustrated in FIG. 3. As illustrated in FIG. 4(c), the following vehicle does not sharply speed up, and therefore runs at a slower vehicle speed than the preceding vehicle. As a result, as illustrated in FIG. 4(b), the inter-vehicle distance undesirably exceeds the target inter-vehicle distance D0 (a circle A drawn with a broken line). Under such a situation, for example, in the vehicle platooning, the inter-vehicle distance increases, which means that the following vehicle collides with another vehicle running behind it, thereby raising a problem, as described above. Because of the undesirable increase in the inter-vehicle distance, the vehicle speed of the following vehicle exceeds the vehicle speed of the preceding vehicle with the aim of reducing the inter-vehicle distance due to the following control, and, after that, the inter-vehicle distance is settled down at the target inter-vehicle distance D0, as illustrated in FIG. 4(c). In this case, after the vehicles start running after being stopped, a significant delay occurs in the following running until the inter-vehicle distance reaches the target inter-vehicle distance sought when the vehicles are running, and this delay should be resolved.

Under these circumstances, the present embodiment will be described below regarding a vehicle control apparatus, a vehicle control method, and a vehicle following running system capable of quickly controlling the inter-vehicle distance to the target inter-vehicle distance sought when the vehicles are running, after the vehicles start running after being stopped.

FIG. 5 is a block diagram illustrating the configuration of the vehicle following running system according to the present embodiment. In FIG. 5, a vehicle control apparatus 10 of the preceding vehicle 1 acquires, for example, an engine torque, a brake hydraulic pressure, an actual steering angle, ABS (Anti-lock Brake System), and TCS (Traction Control System), which are information about an actuator' state A, from a driving device 11, a braking device 12, and a steering device 13. Further, the vehicle control apparatus 10 acquires vehicle motion amount information B of, for example, a vehicle speed/wheel speed sensor 14, an acceleration sensor 15, and a yaw rate sensor 16, and acquires driver's operation information C from a brake pedal sensor 20, an accelerator pedal sensor 19, a steering angle torque sensor 18, and a steering angle sensor 17, which acquire operation amounts on a brake pedal, an accelerator pedal, and a steering wheel operated by a driver. Further, a vehicle motion amount estimation portion 21 estimates how a physical amount (the acceleration, the vehicle speed, and the like) regarding the vehicle motion amount will be based on these pieces of information. Then, the vehicle control apparatus 10 includes a transmission device 22 that transmits these pieces of information as preceding vehicle information.

Because a delay occurs in the communication and the response of the actuator of the following vehicle, the vehicle motion amount estimation portion 21 estimates a slightly future motion amount so as to be able to compensate for this delay. Alternatively, in a case where this delay is slight or the inter-vehicle distance is permitted to be controlled with low control accuracy, the vehicle motion amount estimation unit 21 may carry out the calculation only based on the value of the acceleration sensor and the differential value of the vehicle/wheel speed.

A vehicle control apparatus 30 of the following vehicle 2 includes a reception device 31, a preceding vehicle perception sensor 32, and an actuator control portion 33. The reception device 31 receives the preceding vehicle information transmitted from the vehicle control apparatus 10 of the preceding vehicle 1. The preceding vehicle perception sensor 32 acquires a relative speed, a relative angle, and a relative distance to the preceding vehicle 1. The actuator control portion 33 calculates and outputs control amounts of a driving device 34 such as an engine or a driving motor, a braking device 35, and a steering device 36 based on the received preceding vehicle information and the information from the preceding vehicle perception sensor 32.

The non-mechanical towing is established with use of inter-vehicle communication between the preceding vehicle and the following vehicle in this manner, but the following vehicle may be configured to output an instruction to the actuator control portion so as to cause the following vehicle to start running based on the information from the preceding vehicle perception sensor when the inter-vehicle communication is disconnected.

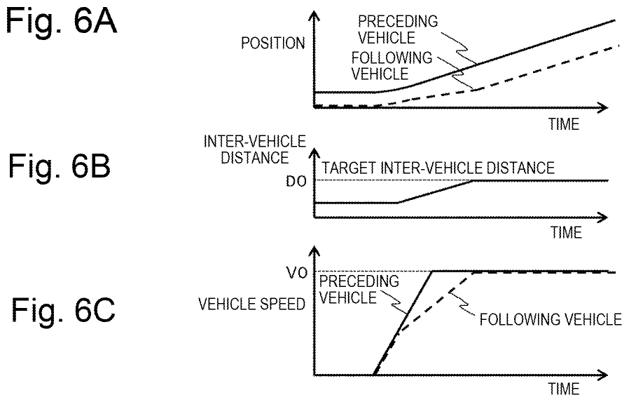

Further, FIG. 6 are timing charts indicating the positions, the inter-vehicle distance, and the vehicle speeds of the preceding vehicle and the following vehicle in the case where the vehicles start running from the state that the vehicles are stopped in the vehicle following running system according to the present embodiment. FIG. 6 illustrate the example in the case where the inter-vehicle distance maintained when the vehicles are stopped is shorter than the target inter-vehicle distance D0 sought when the vehicles are running. The following running is controlled in such a manner that the preceding vehicle and the following vehicle start running simultaneously at synchronized timings and at equal speeds, and, after that, the following vehicle reduces the vehicle speed to increase the inter-vehicle distance to make the inter-vehicle distance closer to the target inter-vehicle distance D0, as illustrated in FIG. 6(c).

Due to this configuration, the present embodiment can provide the vehicle control apparatus, the vehicle control method, and the vehicle following running system capable of quickly controlling the inter-vehicle distance to the target inter-vehicle distance sought when the vehicles are running, after the vehicles start running after being stopped.

In this manner, according to the present embodiment, the vehicle following running system can prevent the delay in the following running when the vehicles start running.

### Second Embodiment

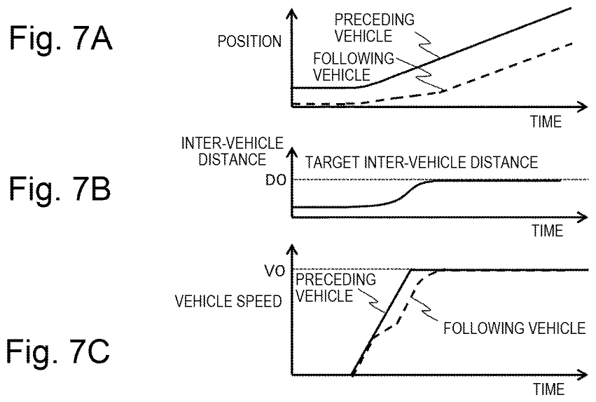

FIG. 7 are timing charts indicating the positions, the inter-vehicle distance, and the vehicle speeds of the preceding vehicle and the following vehicle in the case where the vehicles start running from the state that the vehicles are stopped in a vehicle following running system according to the present embodiment. FIG. 7 illustrate the example in the case where the inter-vehicle distance maintained when the vehicles are stopped is shorter than the target inter-vehicle distance D0 sought when the vehicles are running, similarly to FIG. 6.

In the present embodiment, the following running is controlled in such a manner that the preceding vehicle and the following vehicle start running simultaneously at synchronized timings and at equal speeds, and the following vehicle reduces the vehicle speed to increase the inter-vehicle distance to make the inter-vehicle distance closer to the target inter-vehicle distance D0 after that, and then runs at the equal speed to the preceding vehicle again and gradually reduces the vehicle speed again to make the vehicle speed closer to the target vehicle speed, as illustrated in FIG. 7(c).

In this manner, the present embodiment allows the inter-vehicle distance to be quickly controlled to the target inter-vehicle distance sought when the vehicles are running after the vehicles start running after being stopped, thereby allowing the vehicle following running system to prevent the delay in the following running when the vehicles start running, similarly to the first embodiment.

### Third Embodiment

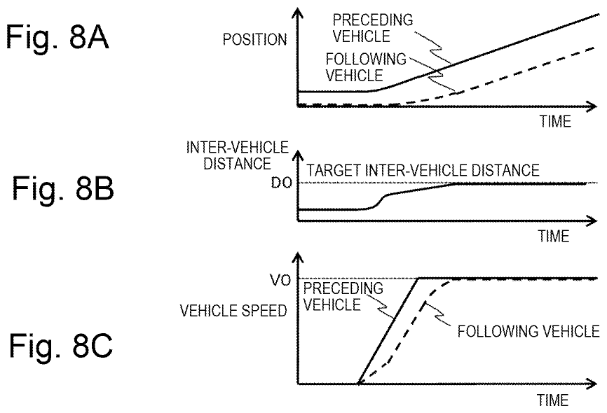

FIG. 8 are timing charts indicating the positions, the inter-vehicle distance, and the vehicle speeds of the preceding vehicle and the following vehicle in the case where the vehicles start running from the state that the vehicles are stopped in a vehicle following running system according to the present embodiment. FIG. 8 illustrate the example in the case where the inter-vehicle distance maintained when the vehicles are stopped is shorter than the target inter-vehicle distance D0 sought when the vehicles are running, similarly to FIGS. 6 and 7.

In the present embodiment, as illustrated in FIG. 8(c), the preceding vehicle and the following vehicle start running at the same time but the following vehicle starts running at a speed changing at a milder gradient than the preceding vehicle. After increasing the inter-vehicle distance to a certain distance, the following vehicle runs at an equal vehicle speed to the preceding vehicle, thereby controlling the inter-vehicle distance so as to make it closer to the target inter-vehicle distance.

In this manner, the present embodiment allows the inter-vehicle distance to be quickly controlled to the target inter-vehicle distance sought when the vehicles are running after the vehicles start running after being stopped, thereby allowing the vehicle following running system to prevent the delay in the following running when the vehicles start running, similarly to the first and second embodiments.

### Fourth Embodiment

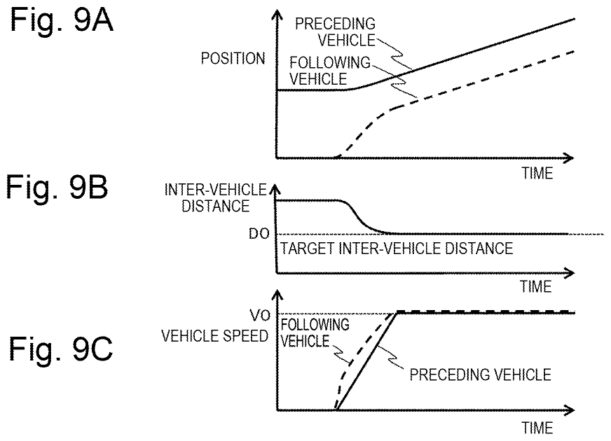

FIG. 9 are timing charts indicating the positions, the inter-vehicle distance, and the vehicle speeds of the preceding vehicle and the following vehicle in the case where the vehicles start running from the state that the vehicles are stopped in a vehicle following running system according to the present embodiment. FIG. 9 illustrate an example in a case where the inter-vehicle distance maintained when the vehicles are stopped is longer than the target inter-vehicle distance D0 sought when the vehicles are running.

In the present embodiment, as illustrated in FIG. 9(c), the preceding vehicle and the following vehicle start running at the same time but the following vehicle starts running at a speed changing at a sharper gradient than the preceding vehicle. By this running, the following vehicle reduces the inter-vehicle distance, thereby controlling the inter-vehicle distance so as to make it closer to the target inter-vehicle distance D0.

The following running may be controlled in such a manner that the following vehicle starts running at an equal speed to the preceding vehicle when the vehicles start running, and, after that, the following vehicle increases the vehicle speed to reduce the inter-vehicle distance to make the inter-vehicle distance closer to the target inter-vehicle distance D0.

In this manner, the present embodiment allows the inter-vehicle distance to be quickly controlled to the target inter-vehicle distance sought when the vehicles are running after the vehicles start running after being stopped, thereby allowing the vehicle following running system to prevent the delay in the following running when the vehicles start running, even in the case where the inter-vehicle distance maintained when the vehicles are stopped is longer than the target inter-vehicle distance sought when the vehicles are running.

Having described the embodiments, the present invention is not limited to the above-described embodiments, and includes various modifications. For example, the above-described embodiments have been described in detail to facilitate a better understanding of the present invention, and the present invention is not necessarily limited to the configuration including all of the described features. Further, a part of the configuration of some embodiment can be replaced with the configuration of another embodiment, and some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2018-163127 filed on Aug. 31, 2018. The entire disclosure of Japanese Patent Application No. 2018-163127 filed on Aug. 31, 2018 including the specification, the claims, the drawings, and the abstract is incorporated herein by reference in its entirety.

### REFERENCE SIGNS LIST

1: preceding vehicle
2: following vehicle
10: vehicle control apparatus of preceding vehicle
11: driving device
12: braking device
13: steering device
14: vehicle speed/wheel speed sensor
15: acceleration sensor
16: yaw rate sensor
17: steering angle sensor
18: steering torque sensor
19: accelerator pedal sensor
20: brake pedal sensor
21: vehicle motion amount estimation portion
22: transmission device
30: vehicle control apparatus of following vehicle
31: reception device
32: preceding vehicle perception sensor
33: actuator control portion
34: driving device
35: braking device
36: steering device

1. A vehicle control apparatus configured to be mounted on a following vehicle in a vehicle following running system that achieves following running by non-mechanically towing a preceding vehicle and the following vehicle,
wherein the vehicle control apparatus acquires a first physical amount regarding a motion amount of the preceding vehicle generated when this preceding vehicle starts running that is transmitted from the preceding vehicle,
determines a second physical amount regarding a motion amount of the following vehicle required when this following vehicle starts running based on the acquired first physical amount, and
outputs an instruction for achieving the determined second physical amount to an actuator regarding driving of the following vehicle.

2. The vehicle control apparatus according to claim 1, wherein the instruction for achieving the second physical amount is an instruction for causing the following vehicle to start running in synchronization with the preceding vehicle.

3. The vehicle control apparatus according to claim 2, wherein the vehicle control apparatus changes an acceleration of the following vehicle after the vehicles start running according to an inter-vehicle distance maintained when the preceding vehicle and the following vehicle are stopped.

4. The vehicle control apparatus according to claim 3, wherein, when the preceding vehicle and the following vehicle start running, the vehicle control apparatus causes the following vehicle to run at an acceleration equal to or lower than the preceding vehicle after the vehicles start running, in a case where the inter-vehicle distance maintained when the vehicles are stopped is shorter than a target inter-vehicle distance sought when the preceding vehicle and the following vehicle are running.

5. The vehicle control apparatus according to claim 4, wherein the vehicle control apparatus reduces the acceleration of the following vehicle before a vehicle speed of the following vehicle becomes equal to a vehicle speed of the preceding vehicle.

6. The vehicle control apparatus according to claim 3, wherein, when the preceding vehicle and the following vehicle start running, the vehicle control apparatus causes the following vehicle to run at an acceleration equal to or higher than the preceding vehicle after the vehicles start running, in a case where the inter-vehicle distance maintained when the vehicles are stopped is longer than a target inter-vehicle distance sought when the preceding vehicle and the following vehicle are running.

7. The vehicle control apparatus according to claim 1, wherein the non-mechanical towing is established with use of inter-vehicle communication between the preceding vehicle and the following vehicle, and
wherein, when this inter-vehicle communication is disconnected, the vehicle control apparatus outputs an instruction for causing the following vehicle to start running to the actuator based on information from a preceding vehicle perception sensor provided to the following vehicle.

8. The vehicle control apparatus according to claim 1, wherein an inter-vehicle distance maintained when the preceding vehicle and the following vehicle are stopped is set to a shorter distance than a target inter-vehicle distance sought when the preceding vehicle and the following vehicle are running.

9. A vehicle control method configured to be performed in a following vehicle in a vehicle following running system that achieves following running by non-mechanically towing a preceding vehicle and the following vehicle, the vehicle control method comprising:
acquiring a first physical amount regarding a motion amount of the preceding vehicle generated when this preceding vehicle starts running that is transmitted from the preceding vehicle;
determining a second physical amount regarding a motion amount of the following vehicle required when this following vehicle starts running based on the acquired first physical amount; and
outputting an instruction for achieving the determined second physical amount to an actuator regarding driving of the following vehicle.

10. The vehicle control method according to claim 9, wherein the instruction for achieving the second physical amount is an instruction for causing the following vehicle to start running in synchronization with the preceding vehicle.

11. A vehicle following running system configured to achieve following running by non-mechanically towing a preceding vehicle and a following vehicle,
wherein the preceding vehicle includes
a vehicle motion amount detection sensor configured to detect a physical amount regarding a motion amount of the preceding vehicle,
a first control portion configured to determine a first physical amount regarding the motion amount of the preceding vehicle generated when the preceding vehicle starts running based on the physical amount regarding the motion amount of the preceding vehicle that is detected by the vehicle motion amount detection sensor, and a signal regarding a state of an actuator regarding braking, driving, or steering of the preceding vehicle, and
a transmission portion configured to transmit the first physical amount determined by the first control portion to the following vehicle, and
wherein the following vehicle includes
a reception portion configured to acquire the first physical amount transmitted from the transmission portion,
a second control portion configured to determine a second physical amount regarding a motion amount of the following vehicle required when the following vehicle starts running based on the first physical amount received by the reception portion, and
an output portion configured to output an instruction for achieving the second physical amount determined by the second control portion to an actuator regarding driving of the following vehicle.

12. The vehicle following running system according to claim 11, wherein the instruction for achieving the second physical amount is an instruction for causing the following vehicle to start running in synchronization with the preceding vehicle.
